(19) United States
(12) Patent Application Publication
(10) Pub. No.: US 2016/0100550 A1
(43) Pub. Date: Apr. 14, 2016

(54) Scratching Device

(71) Applicants: Richard N. Hartley, North Myrtle Beach, SC (US); Rebecca Gale Payne, North Myrtle Beach, SC (US)

(72) Inventors: Richard N. Hartley, North Myrtle Beach, SC (US); Rebecca Gale Payne, North Myrtle Beach, SC (US)

(21) Appl. No.: 14/878,367

(22) Filed: Oct. 8, 2015

Related U.S. Application Data
(60) Provisional application No. 62/061,208, filed on Oct. 8, 2014.

(51) Int. Cl. A01K 13/00; A01K 29/00

(52) U.S. Cl. CPC A01K 13/00; A01K 29/00

(57) ABSTRACT

A scratching device that allows a user to scratch, brush, or rub an animal or person. The scratching device includes an elongated shaft having a proximal end and a distal end forming an interior volume therein. The elongated shaft allows the user to scratch and rub an animal from afar using the proximal end including a plurality of claws used to scratch and rub the animal. The distal end includes a handle that is hand gripped by a user to utilize the elongated shaft and the plurality of claws. The interior volume stores a message playing system configured to allow a user to record an audio message and playback the audio message through a speaker assembly of the message playing system.

### CROSS REFERENCE TO RELATED APPLICATION

This application claims the benefit of U.S. Provisional Application No. 62/061,208 filed on Oct. 8, 2014. The above identified patent application is herein incorporated by reference in its entirety to provide continuity of disclosure.

### BACKGROUND OF THE INVENTION

### Field of the Invention

The present invention relates to scratching devices. More specifically, the present invention pertains to an improved scratching device that includes a message playing system that is configured to soothe and relax an animal while scratching the animal with the same.

Most animals enjoy being animalted or rubbed, particularly dogs. Some dogs love being animalted and having their belly rubbed, and may even solicit animalting or rubbing. In order to do so, dogs usually have to roll over on their backs for a belly rub. Generally, dogs will only be willing to do so for people they trust. At its core, rolling over is a submissive action and behavior, and as aforementioned requires trust from both parties.

While most dogs do tend to enjoy a belly rub, it should never be forced. Often, if a dog is forced onto his back against his will, it will likely create other anxious behaviors, which may cause injury or harm to both parties. There are plenty of other subtler ways to gain a dog's trust. For example, if a person is unsure with the level of comfort felt by the dog towards him, he can always check how tense the dog looks. Generally, a relaxed dog will look loose and floppy, whereas a dog can show signs of discomfort including: tucking his tail between his legs, hunching his body to be quick to stop and move away, and a general higher level of awareness and alertness. However, if the person himself is showing signs of discomfort, generally that will only increase the level of anxiety for the dog. Therefore, there exists a need for a device that allows a user to animal or rub an animal and to soothe the animal or draw the animal's attention.

The present invention provides a scratching device that allows a user to scratch, rub, or brush an animal, an animal, or another person. The scratching device comprises an elongated shaft having a proximal end and a distal end forming an interior volume. The proximal end includes a plurality of claws configured to scratch and rub an animal using a back and forth motion. The distal end includes a handle that is configured for a user to hand grip. The interior volume towards the distal end stores a message playing system that is configured to soothe and relax the animal further to promote trust and comfort between the two parties. The message playing system includes a power source, an activation switch, a recording assembly, a microprocessor, a digital storage medium, and a speaker assembly. The message playing system allows a user to record an audio file for an animal to be played through the speaker assembly.

### SUMMARY OF THE INVENTION

In view of the foregoing disadvantages inherent in the known types of scratching devices now present in the prior art, the present invention provides a new and improved scratching device wherein the same can be utilized for scratching an animal, and soothing or entertaining the animal through a message playing system.

It is therefore an object of the invention to provide a new and improved scratching device that has all of the advantages of the prior art and none of the disadvantages.

Another object of the present invention is to provide a new and improved scratching device including a proximal end having a plurality of claws and a distal end having a handle.

Yet another object of the present invention is to provide a new and improved scratching device having an interior volume in which a music playing system is positioned, wherein the music playing system includes a power source, an activation switch, a recording assembly, a microprocessor, a digital storage medium, and a speaker assembly.

An additional object of the present invention is to provide a new and improved scratching device, wherein said music playing system is configured to allow a user to record an audio file to be played through the speaker assembly, while scratching an animal using the plurality of claws.

Still yet another object of the present invention is to provide a new and improved scratching device wherein said recording assembly includes a recording button, a transducer, a preamplifier, and an analog-to-digital converter.

A further object of the present invention is to provide a new and improved scratching device, wherein said speaker assembly includes a playing button and a speaker system.

Yet a further object of the present invention is to provide a new and improved scratching device, wherein said speaker system includes a digital-to-analog converter, an amplifier, and a speaker.

Still yet another object of the present invention is to provide a new and improved scratching device wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective view of the scratching device.

FIG. 2 shows a front perspective view of the scratching device.

FIG. 3 shows a schematic diagram of the message playing system of the scratching device.

### DETAILED DESCRIPTION OF THE INVENTION

References are made herein to the attached drawings. Like reference numerals are used throughout the drawings to depict like or similar elements of the scratching device. For the purposes of presenting a brief and clear description of the present invention, the preferred embodiment will be discussed as used to scratch an animal from afar, while playing a recorded message for the animal via a message playing system. The figures are intended for representative purposes only and should not be considered to be limiting in any respect.

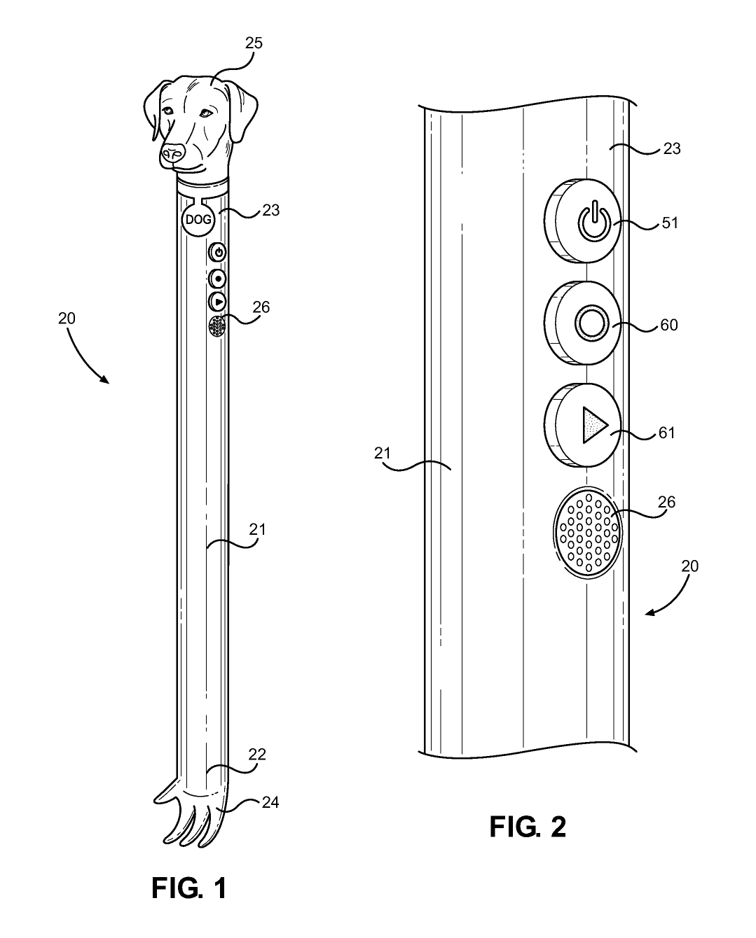

Referring now to FIG. 1, there is shown a side perspective of the scratching device 20. The scratching device 20 is configured to allow a user to scratch an animal without having to physically touch them. The scratching device 20 includes an elongated shaft 21 having a proximal end 22 and a distal end 23 forming an interior volume. Preferably the elongated shaft 21 is cylindrical in shape, however, other embodiments may be constructed of a variety of different shapes and sizes. Preferably, the scratching device 20 is composed thermoset or thermoplastic material, however, it is contemplated that the scratching device 20 is alternatively constructed of other suitable materials. It is likewise contemplated that the elongated shaft 21 can include a variety of lengths, wherein those of ordinary skill in the art will readily envision a variety of lengths of the elongated shaft 21 that are optimal and preferable to scratching an animal.

The proximal end 22 includes a plurality of claws 24 that allows a user to contact the skin and/or body of an animal with the plurality of claws 24 and employ a back and forth motion to provide scratching, grooming and enjoyment for the animal. In some embodiments, the plurality of claws 24 have a paw shaped structure, however, alternative embodiments include a variety of other sizes and shapes for the plurality of claws 24.

In some embodiments, the proximal end 22 further comprises a vibration motor adapted to cause the plurality of claws 24 to vibrate. In this way, the scratching device 20 can be used to provide a soothing or massaging function. Other types of massaging devices may alternately be included in order to provide a massaging function for the scratching device 20. In some embodiments, massaging rollers are disposed on the proximal end 22 of the elongated shaft 21. The rollers are mechanically movable and can be rotated along a surface to provide a massaging effect.

The distal end 23 includes a handle 25 configured to allow a user to more easily grasp the scratching device 20 and that allows the user to direct and guide the scratching device 20. In some embodiments, the handle 25 is in the shape of an animal head, such as a cat or a dog, however it is contemplated that the handle 25 can be a variety of ergonomic shapes and sizes.

The elongated shaft 21 comprises a hollow interior volume in which a message playing system 26 is positioned. The message playing system 26 is configured to allow a user to record audio through a recording assembly to be played through a speaker assembly within the message playing system 26. The message playing system 26 is intended to soothe and relax the animal to promote further comfort and trust between the user and the animal while scratching the animal.

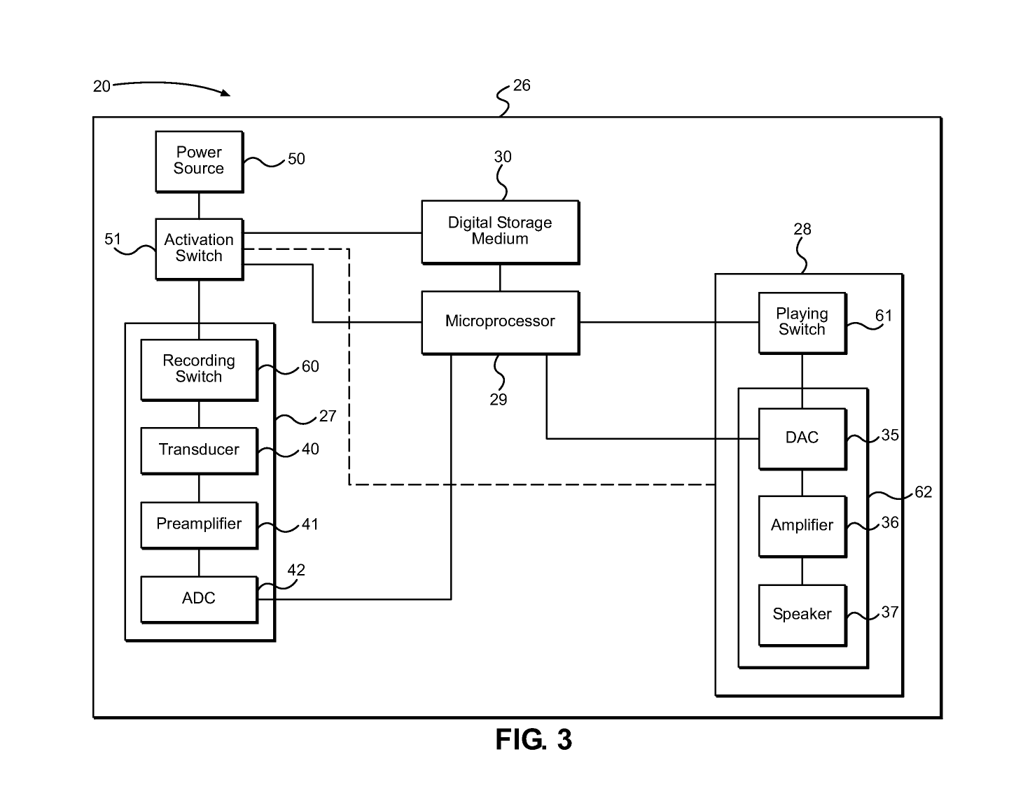

Referring now to FIGS. 2 and 3, there is shown a front perspective view and a schematic diagram of the message playing system 26. The message playing system 26 is configured for recording and playing audio messages. The message playing system 26 comprises a power source 50, an activation switch 51, a recording assembly 27, a microprocessor 29, a digital storage medium 30, and a speaker assembly 28. The recording assembly 27 can include various additional components, and it is not desired to limit the exact construction of the recording assembly 27.

The power source 50 is electrically connected to the activation switch 51, wherein the activation switch 51 provides electrical power to the recording assembly 27, the microprocessor 29, the digital storage medium 30, and the speaker assembly 28. Preferably, the power source 50 includes a battery source such as a rechargeable battery, however other suitable means of power are alternatively used in other embodiments. In addition, it is contemplated that the activation switch 51 is preferably a depressible activation button, however, other alternative embodiments are alternatively composed of other suitable activation switches, such as toggle switches and rocker switches.

The recording assembly 27 is adapted to allow a user to record audio, such as a message, a song, or a tone. The recording assembly 27 preferably comprises a recording switch 60 that can be actuated to allow the user to begin and end recoding a message, sound, or song. The recording assembly 27 further comprises a transducer 40, a preamplifier 41, and an analog-to-digital converter (ADC) 42, which allows a user to record audio messages to soothe and ease an animal while scratching the animal using the proximal end of the scratcher 20. The recording switch 60 is configured to activate the transducer 40, wherein the transducer 40 is configured to convert acoustical energy (sound waves) into electrical energy. Specifically an audio message (a microphone signal) is converted to an audio signal, wherein a user uses the transducer 40 to record an audio message. In the preferred embodiment, the recording switch 60 is a second depressible activation button, however as aforementioned, alternative embodiments may include other suitable switches, such as rocker switches or toggle switches. In addition, the transducer 40 is preferably a microphone, however other suitable transducers 40 are likewise contemplated.

The transducer 40 of the recording assembly 27 is electrically coupled to the preamplifier 41, wherein the preamplifier 41 functions to prepare the microphone signal to be processed by the ADC 42. The preamplifier 41 intensifies low powered audio signals from the transducer 40 to a level suitable to be transmitted to the microprocessor 29. Generally, the audio signal inputted to the preamplifier 41 may only be 1 to 100 microvolt range, however, the preamplifier 41 can output up to preferably 10 volts used to drive the microprocessor 29 and the speaker assembly 28.

The preamplifier of the recording assembly 27 is electrically connected to the ADC 42, wherein the ADC 42 primarily functions to convert the audio signal from the preamplifier 41 to a digital audio file that is transmitted to the microprocessor 29, wherein the microprocessor 29 is configured to transmit the digital audio file to the speaker assembly 28. The microprocessor 29 does not have to be sophisticated as it functions primarily as a pathway between the ADC 42 and the speaker assembly 28, however, the microprocessor 29 is also configured to store and retrieve the digital audio file stored on the digital storage medium 30. Preferably, the digital storage medium 30 is a Random Access Memory (RAM) or a hard drive, however other suitable alternatives are used in other embodiments.

Once an audio message has been recording using the recording assembly 27, the audio message can be played via the speaker assembly 28. The speaker assembly 28 includes a playing switch 61 configured to transmit a digital signal to the microprocessor 29 upon activation by the user. Upon receipt of the digital signal, the microprocessor is prompted to retrieve the digital audio file from the digital storage medium 30 and transmit the retrieved digital audio file to the speaker system 62. The speaker system 62 includes a digital-to-analog converter (DAC) 35, an amplifier 36, and a speaker 37. Preferably, the playing switch 61 is a depressible activation button configured to be hand actuated by the user.

The microprocessor 29 is electrically connected to the DAC 35, wherein the DAC 35 primarily functions to convert the digital audio file retrieved by the microprocessor 29 to an analog signal to drive the speaker 37. The amplifier 36 intensifies generally low powered analog signals from the DAC 35 to a level suitable for driving the speaker 37. Generally, an input analog signal to the amplifier 36 may only be a few hundred microwatts, however, the amplifier 36 can output tens to hundreds of watts based on preference. The speaker 37 receives the output analog signal from the amplifier 36 and plays the digital audio file recorded by the user, which is now in analog signal form. While the message playing system 26 described is used for controlling the functionality of the same, alternatives and equivalents including, but not limited to, other types of controllers, software, hardware, and/or firmware may be suitable.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A scratching device, comprising:
an elongated shaft having a proximal end and a distal end, and an interior volume;
said proximal end having a plurality of claws thereon;
said distal end having a handle configured to allow the user to grip the elongated shaft;
a message playing system disposed within said interior volume configured to record and play an audio message.

2) The scratching device of claim 1, wherein said plurality of claws is a paw shaped structure.

3) The scratching device of claim 1, further comprising a power source for powering said message playing system.

4) The scratching device of claim 1, wherein:
said message playing system includes an activation switch, a recording assembly, a microprocessor, a digital storage medium, and a speaker assembly;
wherein said activation switch is configured to communicate electrical power to said recording assembly, said microprocessor, said digital storage medium; and said speaker assembly.

5) The scratching device of claim 4, wherein said recording assembly comprises:
a recording switch, a transducer, a preamplifier, and an analog-to-digital converter configured to allow a user to record said audio message;
wherein said recording switch is electrically coupled to said transducer and configured to activate said transducer to convert said audio message to an analog signal;
wherein said transducer is electrically coupled to said preamplifier;
said preamplifier is electrically coupled to said analog-to-digital converter;
wherein said analog-to-digital converter is also electrically coupled to said microprocessor;
said microprocessor is electrically coupled to said digital storage medium;
wherein said digital storage medium is configured to store said audio message as a digital audio file.

6) The scratching device of claim 5, wherein said speaker assembly further comprises:
a playing switch and a speaker system;
wherein said speaker system includes a digital-to-analog converter, an amplifier, and a speaker;
wherein said playing switch is electrically connected to said microprocessor;
wherein said microprocessor is also electrically connected to said digital-to-analog converter;
said digital-to-analog converter is electrically connected to said amplifier;
said amplifier is electrically connected to said speaker;
wherein said playing switch is configured to be hand activated to transmit a digital signal to said microprocessor to retrieve said digital audio file from said digital storage medium and transmit said digital audio file to said speaker system;
wherein said speaker system plays said digital audio file as long as said playing switch is activated.

7) The scratching device of claim 6, wherein said playing switch comprises a depressible activation button.

8) The scratching device of claim 7, wherein said recording switch comprises a second depressible activation button.
